(19) United States
(12) Patent Application Publication
(10) Pub. No.: US 2016/0283531 A1
(43) Pub. Date: Sep. 29, 2016

(54) Scalable Data Stream Management System for Monitoring System Activities

(71) Applicant: NEC Laboratories America, Inc., Princeton, NJ (US)

(72) Inventors: Xusheng Xiao, Princeton, NJ (US); Zhichun Li, Princeton, NJ (US); Zhenyu Wu, Plainsboro, NJ (US); Fengyuan Xu, Franklin Park, NJ (US); Guofei Jiang, Princeton, NJ (US)

(21) Appl. No.: 15/063,157

(22) Filed: Mar. 7, 2016

Related U.S. Application Data
(60) Provisional application No. 62/137,414, filed on Mar. 24, 2015.

(51) Int. Cl. G06F 17/30

(52) U.S. Cl. CPC G06F 17/30309; G06F 17/30516; G06F 17/30486

(57) ABSTRACT

A data stream system includes one or more monitored machines generating real-time data stream that describes system activities of the monitored machines; a data stream management module receiving the real-time data stream; and a data stream archiving module coupled to the data stream management module, the data stream archiving module including a data stream receiver and a data stream inserter.

This application claims priority to Provisional Application 62/137,414 filed Mar. 24, 2015, the content of which is incorporated by reference.

The present application relates to archiving real-time data on system activities.

### BACKGROUND

Enterprise systems are complex and keep evolving. It is difficult if not impossible to keep track of security vulnerabilities in such systems; many unknown zero-day vulnerabilities exist today. A promising solution is to monitor the machines inside the enterprise system, notify system administrators whenever abnormal behaviors are detected, and provide support to diagnose the abnormal behaviors. The monitoring data is a real-time data stream that describes system activities of all the monitored machines. To provide accesses to both real-time and historical data and to support subsequent queries and analysis, we propose a Data Stream Management System (DSMS) that archives the monitoring data of system activities.

Conventional systems only focus on how to support continuous queries over continuous streams and traditional stored data sets via computing physical query plans that are flexible enough to support optimizations and fine-grained scheduling decisions. As the bottleneck of archiving system activities is its huge amount of data and the queries rarely span across days, in this work, we investigate how to leverage the characteristics of system activities to improve the data archiving. No existing work has studied the improvement of data archiving from this aspect.

### BRIEF DESCRIPTION OF THE DRAWINGS

The present invention is illustrated by way of example, and not by way of limitation, in the figures of the accompanying drawings and in which:

FIG. 1 shows an exemplary database system receiving and directing a data stream to a data stream management module.

FIG. 2 shows in more details the data stream archiving system.

FIG. 3 shows in more details the data stream archiving module.

FIG. 4 shows in more details the real-time data inserter.

FIG. 5 shows an exemplary system for optimizing the data archiving by exploiting the characteristics of system activities.

FIG. 6 shows an exemplary processing system to which the present principles may be applied, in accordance with an embodiment of the present principles.

FIG. 7 shows a high level diagram of an exemplary physical system including an aging profiling engine, in accordance with an embodiment of the present principles.

### SUMMARY

In one aspect, a data stream system includes one or more monitored machines generating real-time data stream that describes system activities of the monitored machines; a data stream management module receiving the real-time data stream; and a data stream archiving module coupled to the data stream management module, the data stream archiving module including a data stream receiver and a data stream inserter.

In another aspect, the system activities are partitioned by machine and by day, and such partition is leveraged to physically partition the database 103. Next, leveraging the characteristics of the system activities, the system maintains a partial state of system objects that participate in the system activities to perform data deduplication in the memory, greatly reducing the number of times the server accesses database for such purposes. Additionally, since for all the system activities, only a small amount of data requires updates on the stored data, the server can maintain a buffer in the memory to hold the incoming data and perform batch insertion, eliminating the needs of parsing insertion SQLs for each record and improving I/O performance. Such buffer is also used to eliminate the needs of updating data in the database if the data to be updated is still in the buffer and never flushes to the database. Finally, another low-execution-frequency thread is used to insert historical data.

Advantages of the system may include one or more of the following. The system is specialized for optimizing the data archiving by exploiting the characteristics of system activities. The solution is the first in its kind to make data archiving store less duplicated data and become more scalable with low overhead.

### DESCRIPTION

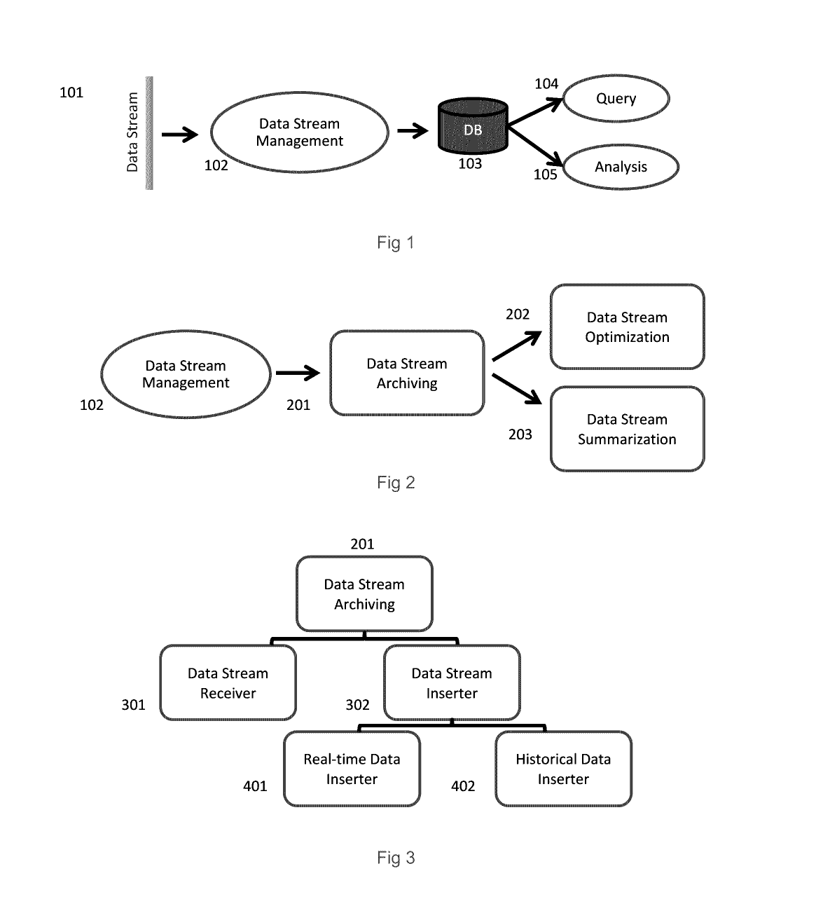

Referring now to the drawings in which like numerals represent the same or similar elements and initially to FIG. 1. FIG. 1 shows an exemplary database system receiving and directing a data stream 101 to a data stream management module 102. The data is saved in a database 103 which can be accessed by a query module 104 and an analysis module 105.

FIG. 2 shows in more details the data stream archiving system. The output of the data stream management module 102 is provided to a data stream archiving module 201. The archiving module 201 in turn communicates with a data stream optimizer module 202 and a data stream summarizer module 203.

FIG. 3 shows in more details the data stream archiving module 201. The module 201 includes a data stream receiver 301 that receives data from the data stream 101. The module 201 also includes a data stream inserter 302, which in turn includes a real-time data inserter 401 and a historical data inserter 402.

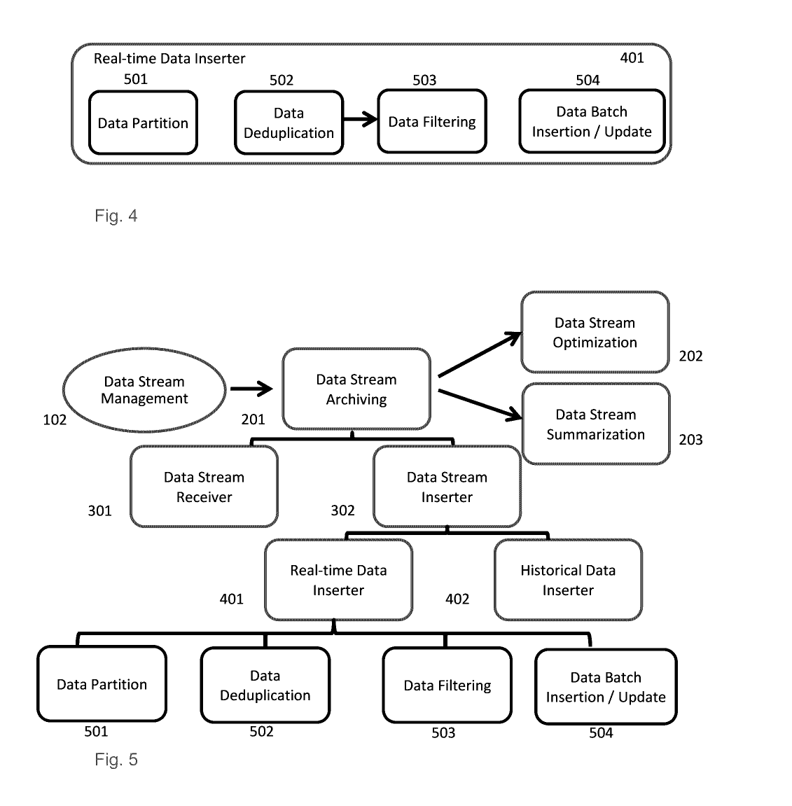

FIG. 4 shows in more details the real-time data inserter 401, which includes a data partition module 501 communicating with a data deduplication module 502. The output of the deduplication module 502 is provided to the data filtering module 503, which drives a data batch insertion/update module 504.

FIG. 5 shows an exemplary system for optimizing the data archiving by exploiting the characteristics of system activities. The system allows the data archiving database to store non-duplicated data and thus scalable with low overhead. The system includes a data stream management module 102 and the output of the data stream management module 102 is provided to a data stream archiving module 201. The archiving module 201 in turn communicates with a data stream optimizer module 202 and a data stream summarizer module 203. The data stream archiving module 201 includes a data stream receiver 301 and a data stream inserter 302, which in turn includes a real-time data inserter 401 and a historical data inserter 402. The real time data inserter 401 can communication with a data partition unit 501, a data deduplication unit 502, a data filtering unit 503, and a data batch insertion/update unit 504. The deduplication unit 502 can quickly locate already-seen system objects from memory by maintaining a partial state of system objects. The unit 504 can maintain buffers to keep incoming data and perform batch insertion. The buffers also enable data update to be applied in memory whenever possible. Depending on the characteristics of the incoming data, the time for the data to stay in the buffer should be configured accordingly, and thus can maximize the probabilities in updating the data in the buffer but not in the database. Unit 402 applies a data update technique that runs in a low-frequency thread to update historical data.

First the system activities are partitioned by machine and by day, and such partition is leveraged to physically partition the database 103. Second, leveraging the characteristics of the system activities, the system maintains a partial state of system objects that participate in the system activities to perform data deduplication in the memory, greatly reducing the number of times the server accesses database for such purposes. Third, since for all the system activities, only a small amount of data requires updates on the stored data, the server can maintain a buffer in the memory to hold the incoming data and perform batch insertion, eliminating the needs of parsing insertion SQLs for each record and improving I/O performance. Such buffer is also used to eliminate the needs of updating data in the database if the data to be updated is still in the buffer and never flushes to the database. As the data is partitioned and inserted in batches, parallel insertion using multi-thread is feasible and the insertion performance could be further improved. Finally, another low-execution-frequency thread is used to insert historical data.

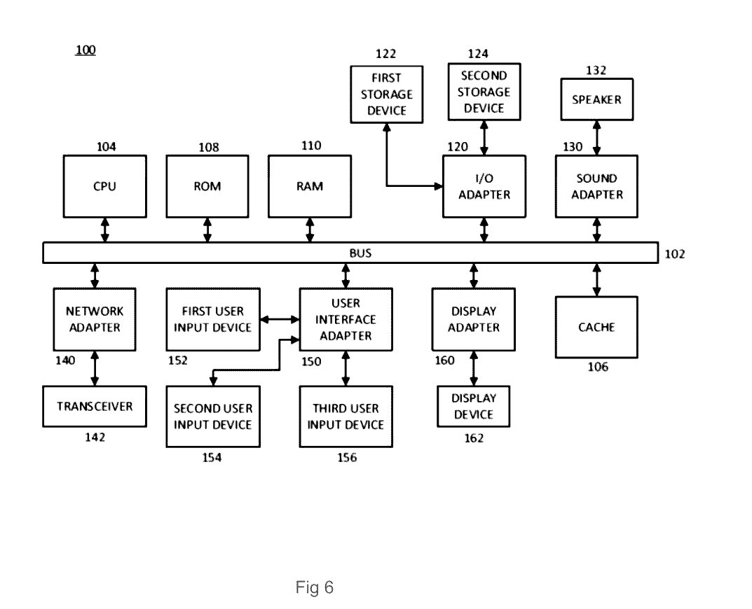

FIG. 6 with an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

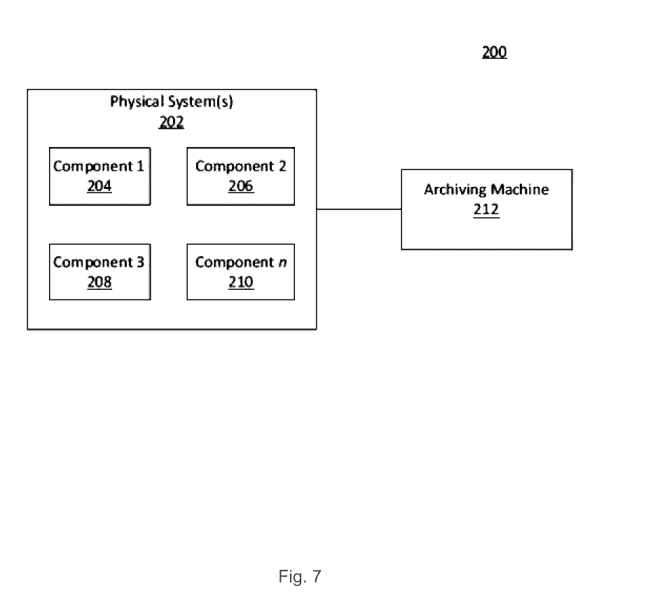

Referring now to FIG. 7, a high level schematic 200 of an exemplary physical system including an archival engine 212 is illustratively depicted in accordance with an embodiment of the present principles. In one embodiment, one or more components of physical systems 202 may be controlled and/or monitored using an archival engine 212 according to the present principles. The physical systems may include a plurality of components 204, 206, 208. 210 (e.g., Components 1, 2, 3, . . . n), for performing various system processes, although the components may also include data regarding, for example, financial transactions and the like according to various embodiments.

In one embodiment, components 204, 206, 208, and 210 may include any components now known or known in the future for performing operations in physical (or virtual) systems (e.g., file access, Internet access, and spawn new processes to handle data, etc.), and data collected from various components (or received (e.g., as time series event data including file events and network events)) may be employed as input to the aging profiling engine 212 according to the present principles. The archival engine/controller 212 may be directly connected to the physical system or may be employed to remotely monitor components of the system according to various embodiments of the present principles.

While the machine-readable storage medium is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A data stream system, comprising:
one or more monitored machines generating real-time data stream that describes system activities of the monitored machines.
a data stream management module receiving the real-time data stream; and
a data stream archiving module coupled to the data stream management module, the data stream archiving module including a data stream receiver and a data stream inserter.

2. The system of claim 1, wherein the data stream archiving module comprises a data stream optimizer.

3. The system of claim 1, wherein the data stream archiving module comprises a data stream summarizer.

4. The system of claim 1, wherein the data stream archiving module comprises a data stream receiver.

5. The system of claim 1, wherein the data stream archiving module comprises a data stream inserter.

6. The system of claim 1, wherein the data stream inserter comprises a historical data stream inserter.

7. The system of claim 5, wherein the data stream inserter comprises a real-time data stream inserter.

8. The system of claim 7, wherein the real-time data stream inserter comprises a data partition module.

9. The system of claim 7, wherein the real-time data stream inserter comprises a data deduplication module.

10. The system of claim 7, wherein the real-time data stream inserter comprises a data filter module.

11. The system of claim 7, wherein the real-time data stream inserter comprises a data batch insertion or update module.

12. A method for protecting data stream, comprising:
partitioning system activities by machine and by time,
using partitioned system activities to physically partition the database.
leveraging the characteristics of the system activities, maintain a partial state of system objects that participate in the system activities to perform data deduplication in memory, reducing the number of times the server accesses database for such purposes.

13. The method of claim 12, comprising maintaining a buffer in memory to hold the incoming data and performing batch insertion, eliminating the needs of parsing insertion SQLs for each record and improving I/O performance.

14. The method of claim 1, wherein the time comprises day.

15. The method of claim 1, comprising using a low-execution-frequency thread to insert historical data.

16. The method of claim 1, wherein the buffer is used to eliminate updating data in the database if the data to be updated is still in the buffer and never flushes to the database.
